(19) United States
(12) Patent Application Publication
(10) Pub. No.: US 2020/0010145 A1
(43) Pub. Date: Jan. 9, 2020

(54) SYSTEM FOR CONTROLLING THE ELECTRIC MOTOR OF A PEDAL-ASSISTED BICYCLE

(71) Applicant: ZEHUS S.p.A., Milano (IT)

(72) Inventors: Paolo LISANTI, Lallio (BG) (IT); Marcello SEGATO, Milano (IT); Daniele BERRETTA, Caronno Pertusella (VA) (IT)

(21) Appl. No.: 16/485,901

(22) PCT Filed: Feb. 13, 2018
(86) PCT No.: PCT/IB2018/050872

§ 371 Date: Aug. 14, 2019

(30) Foreign Application Priority Data
Feb. 16, 2017 (IT) 102017000017186

(51) Int. Cl. B62M 6/50; B62M 6/65; B60L 50/20; B62M 6/90

(52) U.S. Cl. CPC B62M 6/50; B62M 6/65; B60L 2200/12; B62M 6/90; B60L 50/20

(57) ABSTRACT

A system for controlling the electric motor of a pedal-assisted bicycle including a pedal-thrust group and a battery. The control system includes a pedal-thrust cadence sensor a pedal-thrust torque sensor, a bicycle acceleration or speed sensor a motor power detecting sensor a closed-loop controller of the torque, a closed-loop controller of the resisting torque and a dividing. The closed-loop controller of the torque is configured to generate a reference motor command signal based on the cyclist torque The closed-loop controller of the resisting torque is configured to generate a reference motor command signal based on the resisting torque. The dividing module is configured to generate a motor reference command signal based on the reference motor command signal based on the cyclist torque, on the reference motor command signal based on the resisting torque, on the effective resisting torque, and based on a reference dividing parameter.

This application is the National Phase of International Application PCT/162018/050872 filed Feb. 13, 2018 which designated the U.S.

This application claims priority to Italian Patent Application No. 102017000017186 filed Feb. 16, 2017, which application is incorporated by reference herein.

### TECHNICAL FIELD

The present disclosure concerns the sector of pedal-assisted bicycles, that is, a particular type of bicycle equipped with an electric motor that is suitable for supplying additional power with respect to that provided by the user.

The present disclosure finds particular, but not exclusive application in the field of mountain bikes and in the field of racing bicycles.

In particular, the present disclosure concerns a system for controlling the electric motor of the pedal-assisted bicycle.

### DESCRIPTION OF THE RELATED ART

Various control algorithms are known in the field of pedal-assisted bicycles and they principally differ in the aims they intend to achieve. For example, some algorithms prioritize the comfort of the cyclist over battery duration, whereas others aim instead at increasing the autonomy per charge, a result that is essentially achieved by means of regenerative braking by the motor, which in these circumstances operates as a generator that recharges the battery, thus increasing the effort required of the cyclist in some stages of motion.

Alternatively, autonomy is increased by increasing the size of the batteries, resulting in an increase in the weight and dimensions of the bicycle, as well as in increased costs.

### BRIEF SUMMARY

One embodiment of the present disclosure is to provide a system for controlling the electric motor of a pedal-assisted bicycle which makes it possible to optimize management of the energy flows in the bicycle, particularly between the motor and the batteries, and thus to increase autonomy, without compromising the main function of pedal-assistance for the cyclist on the part of the motor.

This aim and others as well are achieved by a control system for controlling the electric motor of a pedal-assisted bicycle according to claim 1.

The dependent claims define possible advantageous embodiments of the disclosure.

### BRIEF DESCRIPTION OF THE SEVERAL VIEWS OF THE DRAWINGS

For a better understanding of the disclosure and appreciation of the advantages thereof, several non-limiting example embodiments shall be described herein below, referring to the attached figures, of which:

FIG. 1 is a schematic side view of a pedal-assisted bicycle equipped with a system for controlling the electric motor thereof according to a possible embodiment of the disclosure;

FIG. 2 is a block diagram of a system for controlling the electric motor of a pedal-assisted bicycle according to a possible embodiment of the disclosure;

FIG. 3 shows a curve illustrating a possible relationship between the resisting torque Tₑₙᵥ, a reference dividing parameter α and a weight β provided by a dividing module of the control system according to a possible embodiment,

FIG. 4 is a schematic illustration of an on-screen display of a user interface device of the control system according to an embodiment of the disclosure.

### DETAILED DESCRIPTION

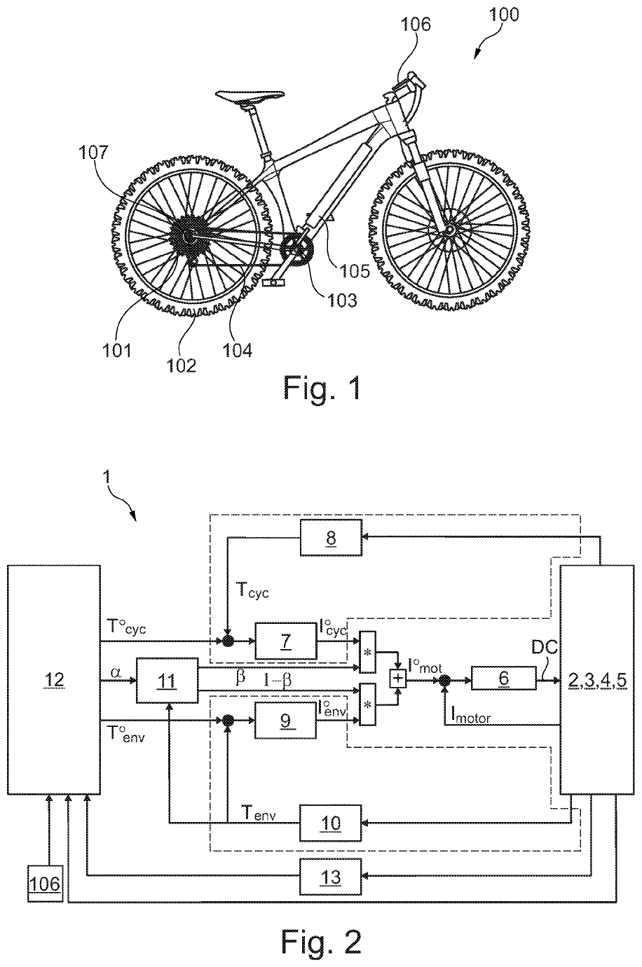

With reference to FIG. 1, a pedal-assisted bicycle is indicated in its entirety by reference number 100.

The bicycle 100 comprises an electric motor 101 associated with one wheel 102 of the bicycle, in particular the rear wheel.

The bicycle 100 further comprises a pedal-thrust group 103, by means of which the user can supply power to the bicycle, and it is connected to one of the wheels, in particular the same wheel 102 with which the motor 101 is associated, by means of a transmission 104, for example a chain drive transmission.

A rechargeable battery 105 is connected to the motor 101, it supplies energy to the motor 101 for its operation and it is recharged by the motor 101 when the motor acts as a generator.

The bicycle 100 comprises a system for controlling the electric motor 1 and FIG. 2 illustrates a possible block diagram representing the operation thereof.

The system 1 comprises a minimum set of sensors underlying the operation of the system.

In particular, these sensors comprise at least:
a pedal-thrust cadence sensor 2 configured to detect cadence, that is, the pedal-thrust rate exerted by the cyclist on the pedal-thrust group 103, and configured to generate a signal representative of the pedal-thrust rate;
a pedal-thrust torque sensor 3 configured to detect the torque applied by the cyclist on the pedal-thrust group 103 and configured to generate a signal representative of the torque applied by the cyclist;
an acceleration or speed sensor 4 configured to generate a signal representative of the acceleration or speed of the bicycle. This sensor can be variously configured. For example, it can comprise an accelerometer, or an angular velocity sensor associated with a wheel, from which it is possible to obtain the linear velocity of the bicycle and, by derivation therefrom, the acceleration of the bicycle;
a sensor 5 for detecting the power of the motor 101 and configured to generate a signal representative of the power of the motor 101; this sensor 5 can be incorporated in the motor 101 or external to the motor.

For example, the power Pₘₒₜ of the motor 101 can be obtained by means of the following relationship:

Pₘₒₜ=P_{batt}·ηₘₒₜₒᵣ=I_{battery}·V_{pack}·ηₘₒₜₒᵣ=Iₘₒₜₒᵣ·DC·V_{pack}·ηₘₒₜₒᵣ

in which:
Iₘₒₜₒᵣ is the current of the motor, which is the quantity that is measured;
DC is the so-called “duty cycle” of the motor;
V_{pack} is the supply voltage of the motor which is supplied by the battery 105;
ηₘₒₜₒᵣ is the efficiency of the motor which generally depends on the rotational speed of the motor.

The motor 101 is in particular controlled by a closed-loop controller 6 that carries out feedback control of the motor, in particular current feedback control.

A motor reference command signal I°ₘₒₜ, which is for example a reference current, is supplied at the input to the closed-loop controller 6 of the motor.

The controller 6 acts in such a manner that the actual current of the motor Iₘₒₜₒᵣ, measured for example by the power sensor 5 described hereinabove, follows the trend of the reference current I°ₘₒₜ.

We shall now describe how the system 1 according to the disclosure determines the motor reference command signal rₘₒₜ.

The system 1 comprises a closed-loop controller 7 of the torque applied by the cyclist on the pedal-thrust group 103.

This controller 7 receives at the input a reference cyclist torque T°_{cyc} and compares it with the effective torque applied by the cyclist T_{cyc}, as measured by the pedal-thrust torque sensor 3. On the basis of the error between these quantities, the controller 7 generates a reference motor command signal based on the cyclist torque I°_{cyc}, which is for example a current signal.

In one embodiment, the controller 7 comprises a filter 8 for filtering the cyclist torque signal, which treats the signal coming from the torque sensor 3. In fact, the pedal-thrust torque generally has an approximately sinusoidal trend, characterized by peaks and troughs.

According to one possible embodiment, the torque filter 8 supplies the value of the torque peaks as the output value of the cyclist torque.

Moreover, the filter 8 in particular filters the signal representative of the cyclist torque in such a manner as to eliminate the noise contained therein.

The system 1 further comprises a closed-loop controller 9 of the resisting torque on the bicycle.

The resisting torque is due to all environmental actions that oppose the advancing movement of the bicycle. This term particularly includes inertia of the bicycle (for example when the bicycle accelerates), the effect of the slope of the road, the effect of wind, and the rolling friction of the wheels.

The controller 9 receives at the input a reference resisting torque T°ₑₙᵥ and compares it with the effective resisting torque Tₑₙᵥ. On the basis of the error between these quantities, the controller 9 generates a reference motor command signal based on the resisting torque I°ₑₙᵥ, which is for example a current signal.

The resisting torque Tₑₙᵥ is determined by the controller 9 on the basis of at least the signals representative of the motor power, pedal-thrust cadence, and bicycle speed or acceleration.

In one embodiment, for the purpose of determining the resisting torque, the controller 9 comprises a resisting torque estimating module 10 (in other words, an estimator).

According to a possible embodiment, the resisting torque estimating module 10 calculates the resisting torque on the basis of the following balance between motor power and resisting power:

Pₘₒₜ+P_{cyclist}·ηₜᵣₐₙₛ=Pₛₚᵣᵢₙₜ+Pₛₗₒₚₑ+P_{wind}+P_{rolling}

in which:
Pₘₒₜ is the power of the motor;
P_{cyclist} is the power supplied by the cyclist resulting from pedal thrust;
ηₜᵣₐₙₛ is the efficiency of the transmission 104 which is known a priori;
Pₛₚᵣᵢₙₜ is the power due to the inertial forces, for example when the bicycle accelerates;
Pₛₗₒₚₑ is the power due to slope;
P_{wind} is the power due to the resisting action of wind;
Pᵣₒₗₗ is the power due to rolling of the wheels.

From the reported balance of powers, it follows that the resisting power Pᵣₑₛᵢₛₜₐₙₜ is given by the following equation:

Pᵣₑₛᵢₛₜₐₙₜ=Pₘₐₜ+P_{cyclist}·ηₜᵣₐₙₛ−Pₛₚᵣᵢₙₜ

All the terms appearing in the equation above are measurable owing to the sensors comprised in the system.

In fact,
motor power Pₘₒₜ can be measured by the motor power sensor 5, for example from the current of the motor Iₘₒₜₒᵣ, according to that which has been stated previously;
cyclist power P_{cyclist} is given by the product of the cyclist torque, which is detectable by the torque sensor 3, and the pedal-thrust rate, which is detectable by the pedal-thrust cadence sensor 2;
power due to inertial forces Pₛₚᵣᵢₙₜ is given by the product of the mass of the bicycle and the cyclist (which can be set each time on the basis of the actual weight of the cyclist or, with greater approximation, it can be set once at a fixed value), acceleration of the bicycle and speed of the bicycle, these two latter values being detectable by the acceleration or speed sensor 4.

The resisting torque Tₑₙᵥ can then be calculated from the resisting power Pᵣₑₛᵢₛₜₐₙₜ thus determined, for example by dividing this latter value by the angular velocity of the wheel 102, this latter value also being determinable from the signal supplied by the acceleration or speed sensor 4.

The system 1 further comprises a dividing module 11 (in other words, a divider) configured to generate the motor reference command signal I°ₘₒₜ from the reference motor command signal based on the cyclist torque I°_{cyc}, from the reference motor command signal based on the resisting torque I°ₑₙᵥ, from the resisting torque Tₑₙᵥ estimated by the resisting torque estimating module 10, and on the basis of a reference dividing parameter α.

The dividing module 11 is realized for example with an electronic circuit mounted on the bicycle 100, particularly by means of an integrated circuit mounted inside the hub of the rear wheel 102 of the bicycle 100.

In particular, the dividing module 11 supplies as output a weight β such that the motor reference command signal I°ₘₒₜ is given by the weighted sum on the basis of the weight β of the reference motor command signal based on the cyclist torque I°_{cyc} and of the reference motor command signal based on the resisting torque I°_{env:}

I°ₘₒₜ=β·I°_{cyc}+(1−β)·I°ₑₙᵥ

in which the weight β is comprised between 0 and 1.

The relationship between the weight β, the resisting torque Tₑₙᵥ and the reference dividing parameter α is in particular predefined.

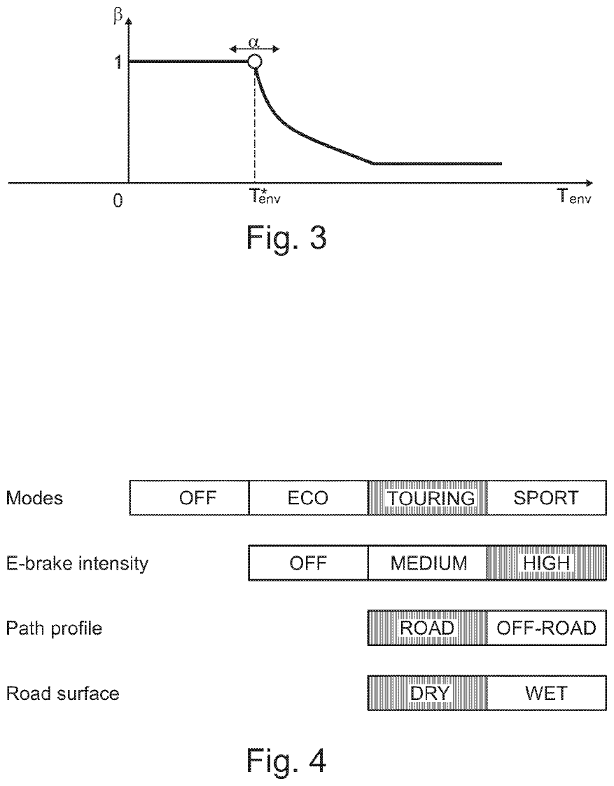

By way of example, FIG. 3 shows a curve that links the weight β and resisting torque Tₑₙᵥ by a constant reference dividing parameter value α.

According to the curve shown, the weight β remains constant and equal to 1 (which means that the motor reference command signal I°ₘₒₜ is equal to the reference motor command signal based on the cyclist torque I_{cyc}) for low values of the resisting torque Tₑₙᵥ to a threshold value Tₑₙᵥ*. For example, this situation can correspond to motion of the bicycle on flat land, or on a route with a low gradient, at a constant speed or with slight variations, in the absence of or with a limited presence of wind. As the resisting torque Tₑₙᵥ increases, for example because the gradient increases, the weight β decreases tending towards zero. This means that as the resisting toque Tₑₙᵥ increases, the contribution of the reference motor command based on the resisting torque I°ₑₙᵥ increases until it becomes preponderant.

By varying the reference dividing parameter α, it is possible, for example, to modify the threshold resisting torque value Tₑₙᵥ*, starting from which the weight β decreases. Low threshold resisting torque values Tₑₙᵥ* lead to frequent intervention of the motor (given that the contribution of the reference motor command based on the resisting torque I°ₑₙᵥ prevails) and thus to the reduction of effort on the part of the cyclist, but also of the autonomy of the bicycle, in a manner that is substantially independent of the pedal-thrust torque of the cyclist, whereas high threshold resisting torque values Tₑₙᵥ* imply a greater effort on the part of the cyclist, due to the greater contribution of the reference motor command signal based on the cyclist torque I°_{cyc}. In this second case, intervention of the motor is generally correlated with the pedal-thrust action of the cyclist.

More specifically, driving torque is generally supplied by the motor for high values of pedal-thrust torque of the cyclist, that is, when there is a high level of effort on the part of the cyclist.

Note that in both conditions, motor interlock is in particular activated only in the presence of pedalling on the part of the cyclist.

When the resisting torque Tₑₙᵥ is negative, that is, when it is a driving torque (which generally results in the bicycle tending to accelerate) the weight p is null and thus the motor reference command signal I°ₘₒₜ is equal to the reference motor command signal based on the resisting torque I°ₑₙᵥ.

The condition consisting of a positive reference resisting torque T°ₑₙᵥ and a negative effective resisting torque Tₑₙᵥ results in a positive error between these two values. Therefore, the reference motor command based on the resisting torque I°ₑₙᵥ shall be a negative current, that is, the motor shall act as a generator, braking the bicycle and recharging the batteries, recovering the kinetic energy of the bicycle.

Referring back to FIG. 2, the system 1 further comprises a reference generating module 12 (in other words, a reference generator) that is configured to generate the previously cited reference cyclist torque T°_{cyc}, reference resisting torque T°ₑₙᵥ, and reference dividing parameter α. These reference values underlying the operation of the system 1 can be generated on the basis of different criteria and on the basis of different inputs.

According to a possible embodiment, the reference generating module 12 receives at the input a command signal from an external device 106 with which the cyclist is equipped, for example a mobile electronic device such as a smartphone or tablet. By means of the external device 106, the cyclist can set the laws that have to be followed by the reference cyclist torque T°_{cyc} and the reference resisting torque T°ₑₙᵥ

For example, the cyclist can select higher or lower constant values for the reference cyclist torque T°_{cyc} so as to calibrate his/her own effort (that is, the pedal-thrust torque he/she must apply) when the reference motor command signal based on the cyclist torque I°_{cyc} prevails (that is, when the weight p is equal to or near 1). Likewise, the cyclist can select higher or lower constant values for the reference resisting torque T°_{cyc} so as to determine the conditions for intervention by the motor when the reference motor command signal based on the resisting torque I°ₑₙᵥ prevails. In this situation, for example, high reference resisting torque T°ₑₙᵥ values will result in less effort on the part of the cyclist even in the presence of very steep uphill routes. Lastly, adjustment of the reference dividing parameter α by the cyclist modifies generation of the weight β, as stated previously with reference to FIG. 3.

Alternatively or additionally, the reference generating module 12 is configured to update the previously cited reference cyclist torque T°_{cyc}, reference resisting torque T°ₑₙᵥ, and reference dividing parameter α automatically on the basis of the signals received at the input.

The modification criteria can be of various types in this additional mode as well.

For example, according to a possible embodiment, the reference generating module 12 is configured in such a manner as to generate the previously cited reference cyclist torque T°_{cyc}, reference resisting torque T°ₑₙᵥ, and reference dividing parameter a on the basis of the charge level of the battery 105 and/or on the basis of the ratio of a gearbox 107, if provided in the transmission 104.This characteristic is schematically illustrated in FIG. 2, including a module 13 for estimating the charge level and/or the transmission ratio of the gearbox 107.

As an example, for low charge levels, the reference generating module 12 will reduce the reference cyclist torque T°_{cyc}, the reference resisting torque T°ₑₙᵥ and the reference dividing parameter α.

Of course, knowledge of the transmission ratio of the transmission 104 is required to obtain the torque actually applied to the wheel as a result of the pedal-thrust torque applied on the pedal-thrust group by the cyclist in the case that this ratio differs from 1.

Alternatively or additionally, the reference generating module 12 is configured in such a manner as to generate the previously cited reference cyclist torque T°_{cyc}, reference resisting torque T°ₑₙᵥ, and reference dividing parameter α on the basis of signals representative of biometric parameter for the cyclist (for example, representing the effort of the cyclist), coming from corresponding sensors, including body temperature sensors or heart rate sensors for example.

Alternatively or additionally, the reference generating module 12 is configured in such a manner as to generate the previously cited reference cyclist torque T°_{cyc}, reference resisting torque T°ₑₙᵥ, and reference dividing parameter α on the basis of signals coming from sensors of the system itself, particularly the pedal-thrust cadence sensor 2 and/or the pedal-thrust torque sensor 3, the bicycle acceleration or speed sensor 4, and/or the sensor 5 for detecting the power/current Iₘₒₜₒᵣ of the motor 101.

For example, the user can set the maximum cruising speed of the bicycle. When the bicycle is travelling downhill, the resisting torque Tₑis negative and the system 1 thus acts in such a manner that the motor 101 acts as a generator, automatically braking the bicycle. If the bicycle speed exceeds the cruising speed value set by the cyclist, the reference generating module 12 modulates the reference resisting torque T°ₑₙᵥ in such a manner that bicycle slows down to a speed equal to the speed set by the cyclist.

For the purpose of enabling the system 1 to set the power delivery/absorption modes, it can be connected to or comprise a user interface device.

For example, this user interface device can be a touchscreen of a smartphone 106 in which a specific software application has been installed.

FIG. 4 shows a possible on-screen display generated by the application running on the smartphone 106 with the following possible parameters that can be set by the user (that is, by the cyclist):
“Modes”: this parameter makes it possible to modify the maximum current of the motor Iₘₒₜ from a null value (“OFF”: which coincides with the deactivated interlocked condition) to a maximum value (“SPORT”) passing through increasing intermediate values (“ECO” and “TOURING”); delivery of the maximum power by the electric motor 101 is modulated in this manner.
“E-brake intensity”: this parameter makes it possible to modify the absolute value of the negative current of the motor when it is acting as a generator, braking the bicycle; it can be modified from a null value (“OFF”, which coincides with the null energy recovery condition) to a maximum value (“HIGH”, which coincides with the maximum energy recovery condition), passing through an intermediate value (“MEDIUM”).
“Path profile”: this parameter makes it possible to set energy recovery by the motor acting as a generator, a condition corresponding to braking, in a deactivation condition (“OFF-ROAD”) or in an automatic activation condition (“ROAD”) according to the operation of the system 1 described hereinabove. Note that in the automatic activation condition, under certain conditions, for example when the bicycle is travelling downhill, braking is activated automatically with a certain intensity, which depends, among other factors, on the “E-brake intensity” parameter. In one embodiment, in the case in which the “Path Profile” parameter is set on “ROAD”, the system 1 also allows for activation of additional manual braking by the cyclist, which is always realized by making the motor function as a generator. For example, this manual braking can be activated by pedalling backwards or by means of a specific control, which can be arranged on the handlebars of the bicycle. In the case in which the “Path profile” parameter is set on “OFF-ROAD”, the cyclist can activate manual braking, for example by pedalling backwards, or manually activate automatic braking, for example by using a specific control.
“Road surface”: this parameter further modulates the negative current of the motor for automatic braking, so that the braking action is different under wet (“WET”) road and dry (“DRY”) road conditions.

Note that in this description and in the appended claims, the system 1, as well as the elements indicated by the term “module”, can be implemented by means of hardware devices (e.g. control units or processing units), by means of software or by means of a combination of hardware and software.

For example, the controller 7 of the torque applied by the cyclist and the controller 9 of the resisting torque on the bicycle are implemented by means of a suitable software code running on a processing unit (e.g. a microprocessor or microcontroller) mounted on the bicycle 100, particularly inside the hub of the rear wheel.

Alternatively, the controller 7 of the torque applied by the cyclist and the controller 9 of the resisting torque on the bicycle are implemented by means of one or more electronic circuits mounted on the bicycle 100, particularly by means of an integrated circuit mounted inside the hub of the rear wheel 102.

For the purpose of meeting specific contingent needs, a person skilled in the art can introduce numerous additions, modifications or replacements of elements with other functionally equivalent elements in the disclosed embodiments of the system for controlling the electric motor of the pedal-assisted bicycle according to the disclosure, without, however, deviating from the scope of the appended claims.

1. A system for controlling the electric motor of a pedal-assisted bicycle comprising said electric motor coupled to a wheel of the bicycle, a pedal-thrust group connected to a wheel of the bicycle, a battery configured to exchange energy with the motor, said control system comprising:
a pedal-thrust cadence sensor configured to detect a pedal-thrust rate exerted by a cyclist on the pedal-thrust group and configured to generate a signal representative of the detected pedal-thrust rate;
a pedal-thrust torque sensor configured to detect a torque applied by the cyclist on the pedal-thrust group and configured to generate a signal representative of the torque applied by the cyclist;
an acceleration or speed sensor of the bicycle, configured to generate a signal representative of the acceleration and speed of the bicycle;
a sensor for detecting the power of the motor and configured to generate a signal representative of the detected power of the motor;
a closed-loop controller of the torque applied by the cyclist on the pedal-thrust group, configured to generate a reference motor command signal based on the cyclist's torque based on the error between a reference cyclist torque and the cyclist effective applied torque detected by said pedal-thrust torque sensor;
a closed-loop controller of the resisting torque of the bicycle, configured to generate a reference motor command signal based on the resisting torque based on the error between a reference resisting torque and an effective resisting torque determined based on at least said signals representative of the motor power, of the pedal-thrust cadence, and of the bicycle speed or acceleration;
a dividing module configured to generate a motor reference command signal based on said reference motor command signal based on the cyclist's torque, on said reference motor command signal based on the resisting torque, on said effective resisting torque, and based on a reference dividing parameter;

2. The control system according to claim 1, comprising a reference generating module configured to change the value of the reference dividing parameter.

3. The control system according to claim 1, wherein said dividing module is configured to determine a weight so that the motor reference command signal is obtained by the weighted sum based on said weight of the reference motor command signal based on the cyclist's torque and of the reference motor command signal based on the resisting torque, said weight being determined on the basis of a predefined relationship between the weight, the effective resisting torque and the reference dividing parameter.

4. The control system according to claim 3, wherein the dividing module is configured so that the motor reference command signal is obtained by the following relationship:
I°ₘₒₜ=β·I°_{cyc}+(1−β)·I°ₑₙᵥ
wherein:
I°ₘₒₜ is the motor reference command signal;
I°_{cyc} is the reference motor command signal based on the cyclist's torque;
I°ₑₙᵥ is the reference motor command signal based on the resisting torque;
β is said weight, comprised between 0 and 1.

5. The control system according to claim 3, wherein the dividing module is configured so that said weight β has values so that the motor reference command signal is equal to the reference motor command signal based on the resisting torque when the effective resisting torque is a negative torque, that is a driving torque, so that, for positive values of the reference resisting torque, the motor reference command signal is such that the motor acts as a generator by exerting an automatic braking action on the bicycle which increases as the error between the reference resisting torque and the effective resisting torque increases.

6. The control system according to claim 3, wherein the dividing module is configured so that said weight takes values so that, when the effective resisting torque is positive:
the motor reference command signal is equal to the reference motor command signal based on the cyclist's torque when the effective resisting torque is less than a threshold resisting torque value;
the contribution of the reference motor command signal based on the resisting torque to the motor reference command signal increases as the value of the effective resisting torque increases with respect to the threshold resisting torque value when the effective resisting torque is greater than said threshold resisting torque value,
wherein the threshold resisting torque value is variable as a function of the reference dividing parameter.

7. The control system according to claim 1, wherein said closed-loop controller of the torque applied by the cyclist on the pedal-thrust group comprises a filter of the cyclist torque signal supplied by said pedal-thrust torque sensor, configured to generate the output value of the peaks of the cyclist torque signal supplied by said pedal-thrust torque sensor.

8. The control system according to claim 1, wherein said closed-loop controller of the resisting torque on the bicycle comprises a resisting torque estimating module configured to calculate the resisting power based on the following relationship:
Pᵣₑₛᵢₛₜₐₙₜ=Pₘₒₜ+P_{cyclist}·ηₜᵣₐₙₛ−Pₛₚᵣᵢₙₜ
wherein:
Pₘₒₜ is the power of the motor detected by said sensor detecting the motor power;
P_{cyclist} is the power supplied by the cyclist due to the effect of the pedal-thrust, determined from said signals representative of the pedal-thrust torque and of the pedal-thrust speed;
ηₜᵣₐₙₛ is the efficiency of a transmission arranged between the pedal-thrust group and said bicycle wheel;
Pₛₚᵣᵢₙₜ is the power due to the inertial forces, determined from said signal representative of the acceleration or speed of the bicycle.

9. The control system according to claim 1, wherein said reference generating module is configured to determine said reference cyclist, said reference resisting torque and said reference dividing parameter automatically based on 1 said signal representative of the pedal-thrust cadence, and/or based on said signal representative of the pedal-thrust torque, and/or based on said signal representative of the acceleration or speed of the bicycle, and/or based on said signal representative of the motor power.

10. The control system according to claim 1, comprising a reference generating module configured to generate said reference cyclist torque, said reference resisting torque and said reference dividing parameter.

11. The control system according wherein said reference generating module is connected to an external device commandable by the cyclist and is configured to generate a cyclist command signal, wherein the reference cyclist torque, the reference resisting torque and the reference dividing parameter are determined by the reference generating module based on said cyclist command signal supplied by the external device.

12. the control system according to claim 1, comprising a module for estimating the state of charge of said battery and which is configured to generate a signal representing this estimate, wherein the reference generating module is configured to determine said reference cyclist torque, said reference resisting torque and said reference dividing parameter automatically on the basis of said signal representative of the state of charge of the battery.

13. The control system according to claim 1, comprising a module for estimating the transmission ratio of a transmission disposed between the pedal-thrust group and said bicycle wheel, wherein the reference generating module is configured to determine said reference cyclist torque, said reference resisting torque and said reference dividing parameter automatically based on said signal representative of the transmission ratio of said transmission.

14. The control system according to claim 1, comprising one or more sensors for detecting biometric parameters of the cyclist, suitable for generating signals representative of the same, wherein the reference generating module is configured to determine said reference cyclist torque, said reference resisting torque and said reference dividing parameter automatically based on said signals representative of the biometric parameters of the cyclist,
the system further comprising a closed-loop controller configured to perform a current feedback control of the motor based on said motor reference command signal, wherein the motor effective current is supplied by said sensor for detecting the motor power (101).

15. A pedal-assisted bicycle comprising an electric motor coupled to a wheel, a pedal-thrust group connected to a wheel, a rechargeable battery capable of exchanging energy with the electric motor, and a control system of the electric motor according to claim 1.
